(19) United States
(12) Patent Application Publication
(10) Pub. No.: US 2024/0037370 A1
(43) Pub. Date: Feb. 1, 2024

(54) AUTOMATED DATA FORECASTING USING MACHINE LEARNING

(71) Applicant: CITIZENS FINANCIAL GROUP, INC., PROVIDENCE, RI (US)

(72) Inventors: Jason Chun Sing Chan, Kowloon (HK); Richard Saunders, Granby, MA (US); Ryan Murray, Providence, RI (US); Yuchen Hua, Providence, RI (US); Adrian Yu Hin Lam, Seattle, WA (US); Sri Chaitanya Somanchi, Cranston, RI (US); Noam Katz, Lincoln, RI (US)

(21) Appl. No.: 18/484,847

(22) Filed: Oct. 11, 2023

Related U.S. Application Data
(63) Continuation-in-part of application No. 17/519,056, filed on Nov. 4, 2021, now Pat. No. 11,803,793.
(60) Provisional application No. 63/110,801, filed on Nov. 6, 2020.

(51) Int. Cl. G06N 3/0442; G06N 3/08

(52) U.S. Cl. CPC G06N 3/0442; G06N 3/08

(57) ABSTRACT

A system and method are disclosed herein. The system includes one or more processors and a memory having programming instructions stored thereon, which, when executed by the one or more processors, performs operations. The operations include retrieving historical account activity. The operations further include constructing a training data set that includes the historical inflow data, the historical outflow data, and known forecast information from the historical account activity. The operations further include generating a combined prediction model configured to forecast future inflow activity and future outflow activity. The operations further include receiving current inflow activity, current outflow activity, and current balance information for a user. The operations further include generating a predicted account balance by forecasting, by the prediction model, a future inflow and a future outflow and constructing the predicted account balance based on the future inflow, the future outflow, and the current balance information.

### CROSS REFERENCE TO RELATED APPLICATIONS

This application is a continuation-in-part of U.S. patent application Ser. No. 17/519,056, filed on Nov. 4, 2021, which claims the benefit of U.S. Provisional Patent Application No. 63/110,801, filed on Nov. 6, 2020.

### TECHNICAL FIELD

The present disclosure generally relates to a system and method for generating automated data forecasts using machine learning.

### BACKGROUND

Accurately capturing a snapshot of a user's account activity is a critical component to both an individual's forecasted outlook as well as a business or organization's forecasted outlook. While there are several solutions for users to gain insight to their financial projections, such solutions suffer from a variety of deficiencies due to their inability to account for incremental errors that, over time, lead to erroneous projections. In addition, existing solutions lack the infrastructure and technology to generate large scale multi-step, multi-variate and/or multi-entity forecasts.

### SUMMARY

In some embodiments, a system is disclosed herein. The system includes one or more processors and a memory. The memory has programming instructions stored thereon, which, when executed by the one or more processors, performs operations. The operations include retrieving historical account activity for a plurality of users. The historical account activity includes historical inflow data and historical outflow data. The operations further include constructing a training data set that includes the historical inflow data, the historical outflow data, and known forecast information from the historical account activity. The operations further include generating a combined prediction model configured to forecast future inflow activity and future outflow activity. The generating includes learning, by the prediction model, to forecast the future inflow activity and the future outflow activity based on the training data set, the learning comprising optimizing an objective function of the combined prediction model by penalizing errors for projected inflow predictions, projected outflow predictions, and differences between the projected inflow predictions and projected outflow predictions to reduce a drift in forecasted values. The operations further include receiving, from one or more third-party systems, current inflow activity, current outflow activity, and current balance information for a user. The operations further include generating a predicted account balance by forecasting, by the prediction model, a future inflow and a future outflow and constructing the predicted account balance based on the future inflow, the future outflow, and the current balance information.

In some embodiments, a system is disclosed herein. The system may include one or more processors and memory storing programming instructions that, when executed by the one or more processors, cause the system to retrieve historical account activity data for a plurality of accounts, where the historical account activity data may include historical inflow data and historical outflow data. The system may then construct a training data set based on the historical account activity data. Next, the system may generate a combined prediction model configured to forecast future inflow activity and future outflow activity for a multi-step time horizon. In addition, the system may train the combined prediction model based on the training data set. The training may comprise optimizing an objective function of the prediction model by adjusting at least one weight parameter of the objective function based on an accuracy of one or more predictions generated by the combined prediction model during said training. The predictions may comprise a combination of projected inflow predictions, projected outflow predictions and differences between the projected inflow predictions and the projected outflow predictions. The system may also receive, from one or more third-party systems, current inflow activity data, current outflow activity data, and current balance information associated with one or more target accounts. Then, based on a combination of the current inflow activity data, the current outflow activity data, and the current balance information, the system may cause the combined prediction model to generate a future inflow forecast and a future outflow forecast for the one or more target accounts. The future inflow forecast may comprise an inflow forecast for each of a plurality of time steps in the multi-step time horizon, and the future outflow forecast may comprise an outflow forecast for each of a plurality of time steps in the multi-step time horizon. The system may then determine, based on the future inflow forecast and the future outflow forecast, a future balance forecast for the one or more target accounts that comprises a balance forecast for each of a plurality of time steps in the multi-step time horizon. The system may also retrain the combined prediction model by evaluating a performance of the combined prediction model based on one or more performance metrics, determining whether at least one among the one or more performance metrics falls below a predetermined threshold based on the evaluating, adjusting the at least one weight parameter based on said determining, and optimizing the objective function based on the adjusted at least one weight parameter.

In some embodiments, a method is disclosed herein. Historical account activity for a plurality of users is retrieved. The historical account activity includes historical inflow data and historical outflow data. A training data set that includes the historical inflow data, the historical outflow data, and known forecast information from the historical account activity is constructed. A combined prediction model configured to forecast future inflow activity and future outflow activity is generated. The generating includes learning, by the prediction model, to forecast the future inflow activity and the future outflow activity based on the training data set, the learning comprising optimizing an objective function of the combined prediction model by penalizing errors for projected inflow predictions, projected outflow predictions, and differences between the projected inflow predictions and projected outflow predictions to reduce a drift in forecasted values.

In some embodiments, a method is disclosed herein. The method may be executed by a system comprising one or more processors executing programming instructions stored in memory. The method may include retrieving historical account activity data for a plurality of accounts, where the historical account activity data may include historical inflow data and historical outflow data. The method may further include constructing a training data set based on the historical account activity data. Next, the method may include generating a combined prediction model configured to forecast future inflow activity and future outflow activity for a multi-step time horizon. In addition, the method includes training the combined prediction model based on the training data set. The training may comprise optimizing an objective function of the prediction model by adjusting at least one weight parameter of the objective function based on an accuracy of one or more predictions generated by the combined prediction model during said training. The predictions may comprise a combination of projected inflow predictions, projected outflow predictions and differences between the projected inflow predictions and the projected outflow predictions. The method may further include receiving, from one or more third-party systems, current inflow activity data, current outflow activity data, and current balance information associated with one or more target accounts. Then, based on a combination of the current inflow activity data, the current outflow activity data, and the current balance information, the method may include generating, by the combined prediction model, a future inflow forecast and a future outflow forecast for the one or more target accounts. The future inflow forecast may comprise an inflow forecast for each of a plurality of time steps in the multi-step time horizon, and the future outflow forecast may comprise an outflow forecast for each of a plurality of time steps in the multi-step time horizon. The method may then proceed to determining, based on the future inflow forecast and the future outflow forecast, a future balance forecast for the one or more target accounts that comprises a balance forecast for each of a plurality of time steps in the multi-step time horizon. The method may include retraining the combined prediction model by evaluating a performance of the combined prediction model based on one or more performance metrics, determining whether at least one among the one or more performance metrics falls below a predetermined threshold based on the evaluating, adjusting the at least one weight parameter based on said determining, and optimizing the objective function based on the adjusted at least one weight parameter.

In some embodiments, a non-transitory computer readable medium is disclosed herein. The non-transitory computer readable medium includes one or more sequences of instructions, which, when executed by one or more processors, causes a computing system to perform operations. The operations include receiving, by a computing system, current inflow activity, current outflow activity, and current balance information for a user. The operations further include generating, by the computing system, future forecasts for the user using a combined prediction model trained to forecast future inflow activity and forecast future outflow activity by forecasting, by the combined prediction model, a future inflow and a future outflow based on the current inflow activity, current outflow activity, and the current balance information for the user. The operations further include constructing, by the computing system, future balance data based on the future inflow and the future outflow. The operations further include presenting, by the computing system, the future inflow, the future outflow, and the future balance data to the user.

In some embodiments, a non-transitory computer readable medium is disclosed herein. The non-transitory computer readable medium includes one or more sequences of instructions, which, when executed by one or more processors, causes a computing system to perform operations. The operations may include retrieving historical account activity data for a plurality of accounts, where the historical account activity data may include historical inflow data and historical outflow data. The operations may further include constructing a training data set based on the historical account activity data. Next, the operations may include generating a combined prediction model configured to forecast future inflow activity and future outflow activity for a multi-step time horizon. In addition, the operations may include training the combined prediction model based on the training data set. The training may comprise optimizing an objective function of the prediction model by adjusting at least one weight parameter of the objective function based on an accuracy of one or more predictions generated by the combined prediction model during said training. The predictions may comprise a combination of projected inflow predictions, projected outflow predictions and differences between the projected inflow predictions and the projected outflow predictions. The operations may further include receiving, from one or more third-party systems, current inflow activity data, current outflow activity data, and current balance information associated with one or more target accounts. Then, based on a combination of the current inflow activity data, the current outflow activity data, and the current balance information, the operations may include generating, by the combined prediction model, a future inflow forecast and a future outflow forecast for the one or more target accounts. The future inflow forecast may comprise an inflow forecast for each of a plurality of time steps in the multi-step time horizon, and the future outflow forecast may comprise an outflow forecast for each of a plurality of time steps in the multi-step time horizon. The operations may then proceed to determining, based on the future inflow forecast and the future outflow forecast, a future balance forecast for the one or more target accounts that comprises a balance forecast for each of a plurality of time steps in the multi-step time horizon. The operations may include retraining the combined prediction model by evaluating a performance of the combined prediction model based on one or more performance metrics, determining whether at least one among the one or more performance metrics falls below a predetermined threshold based on the evaluating, adjusting the at least one weight parameter based on said determining, and optimizing the objective function based on the adjusted at least one weight parameter.

### BRIEF DESCRIPTION OF DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating back-end computing system of the computing environment of FIG. 1, according to one or more embodiments disclosed herein.

FIG. 3 illustrates an exemplary graphical user interface (GUI) generated by interface module, according to example embodiments.

FIG. 4 is a flow diagram illustrating a method of generating a forecast module, according to example embodiments.

FIG. 5 is a flow diagram illustrating a method of generating user forecasts, according to example embodiments.

FIG. 6A is a block diagram illustrating a computing device, according to example embodiments.

FIG. 6B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques described herein are generally directed to a system and method for forecasting cash flow for one or more customers using one or more artificial intelligence processes. The forecasting may be implemented on an account level (e.g., for selected account(s) from among any number of accounts associated with a particular customer), on the customer level (e.g., across all accounts associated with the particular customer), and/or across a user base clusters (e.g., across multiple customers' accounts). In some embodiments, the system may include a machine learning platform trained to forecast future customer activity based on historical customer activity, including for accounts for which the system has not been trained. Such functionality aims to assist clients to forecast their cash balances by considering net inflow and outflow activity.

Inflow activity may be broadly defined as money entering a user's account or accounts. Example inflow activity may include a cash deposit, accrued interest, and the like. Outflow activity may be broadly defined as money leaving a user's account. Example outflow activity may include debits from a user's account. Together, inflow activity and outflow activity may be used to generate a user's current account balance. For example, a user's account balance at the end of a given day may be defined as the user's starting balance plus a sum of the daily changes (e.g., inflow activity and outflow activity).

Currently, conventional systems for forecasting a user's account balance suffer from one or more limitations. The error in forecast gets compounded when individual forecasts for inflow and outflow are combined to generate a cash balance. Over time, the error may get accumulated, resulting in a less accurate prediction. For example, due to the fluid nature of customer inflow and outflow data, over time, the various machine learning processes (or other forecasting methods) implemented by conventional systems become less accurate. Over time, the accumulation of less accurate forecasts may result in a prediction “drift.” A drift may be present when forecast errors occur on a daily basis due to the volatile nature of customer inflow and outflow data, or the presence of a small bias in the forecast. As these small, daily, forecast errors accumulate, the forecasted balance tends to drift increasingly farther away from the actual balance. In other words, over time, the forecasting models implemented by conventional systems become less accurate. Conventional systems currently have no methodology to account for such drift problems. This drift may be eliminated, of course, by forecasting balance directly, instead of forecasting separate inflow and separate outflow. The downside to such elimination, however, is that separate inflow forecasts and outflow forecasts are more useful to an end user than the balance forecast, by itself.

In addition, conventional forecasting systems are limited to univariate and uni-entity forecasting. That is, existing forecasting models are only able to handle forecasting tasks for a single variable and/or a single entity at a time. As a result, performing forecasting tasks for multiple entities necessarily requires building multiple, separate models (i.e., one for each different entity). Furthermore, since these existing models are inherently unable to perform multivariate forecasting, there currently does not exist a tool for overcoming this deficiency.

Further still, in the context of time series forecasting, existing forecasting models are limited insofar they are only capable of generating forecasts for one time-step (e.g., one day) at a time. Recursion is then used (e.g., use of prior time-step forecast to determine a next time-step forecast) to generate forecasts for subsequent time-steps. As will be appreciated, however, this approach is prone to propagating errors, particularly as the number of forecasted times-steps increases. For example, a slight error in an early forecasted time-step can lead to an error that is exponentially larger in a later forecasted time-step. Said another way, the (slight) error is compounded when using the recursive method of generating multiple time step forecasts.

The one or more techniques described herein overcomes the drift problem plaguing conventional systems by combining one or more machine learning models trained to forecast inflow data and outflow data separately into a single model, thus limiting the error in the balance forecast. However, even accurate inflow and outflow forecasts may result in a poor or inaccurate balance forecast. In order to account for this possibility, the one or more techniques described herein also accounts for the difference between the forecasted inflow and outflow data. The difference between the forecasted inflow and outflow data may correspond to a change in account balance.

The systems and methods described herein also overcome the forecasting deficiencies described above providing a new type of deep learning machine learning model(s) (also referred to herein as prediction model(s)) that is configured to learn from historical data from across multiple accounts, intake multiple variable inputs, and generate multi-variable, multi-step forecasts (e.g., multiple days in a time horizon) for multiple entities, all at once. In this regard, the deep learning prediction model(s) described below may be characterized as a centralized, multi-entity, multi-step and multi-variable time series forecasting model(s). As will be discussed in detail below, the systems, methods and prediction model(s) of the present disclosure are uniquely configured to learn and/or identify seasonality trends, periodicity (e.g., identify events that happen on a periodic basis), generalizability (e.g., applicability of prediction model to accounts and/or time series data on which the prediction model has not been trained), interdependencies between variables, potential relationships between various entities, and to produce comprehensive multi-step time series forecasts all as once (e.g., 90+ days). The prediction model(s) of the present disclosure may also be customizable, insofar as parameters such as look back period (e.g., period of historical data that may be used to train the prediction model(s)), time horizon (e.g., forecast time-steps), number of accounts, number of entities for which forecasts are generated, number of variables modeled, etc. may all be customized for the particular implementation.

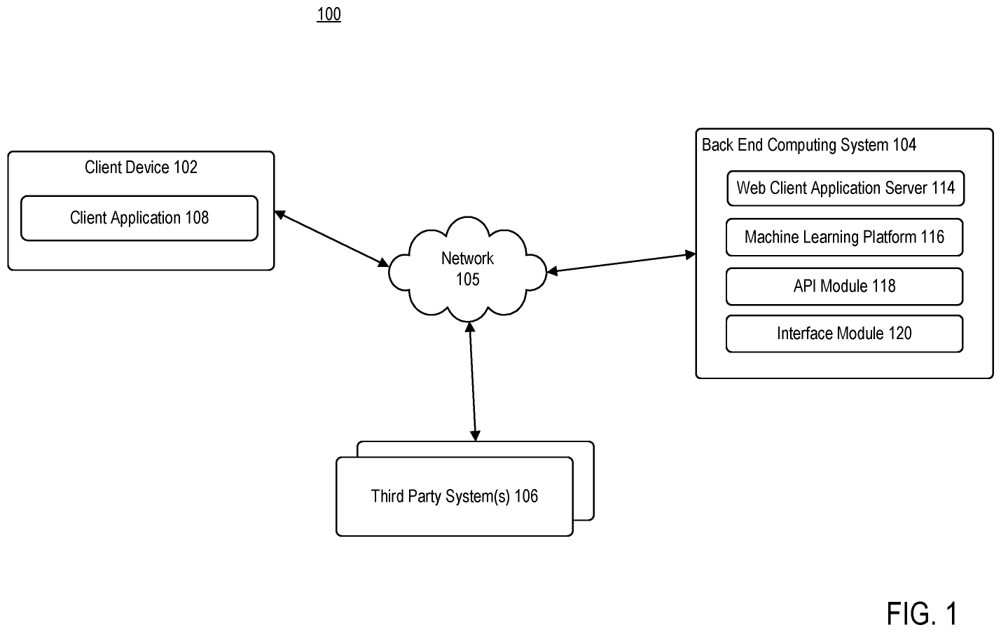

FIG. 1 is a block diagram illustrating a computing environment 100, according to example embodiments. Computing environment 100 may include one or more client devices 102 (generally, client device 102), back-end computing system 104, and one or more third-party systems 106 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Client device 102 may be in communication with back-end computing system 104 via network 105. Client device 102 may be operated by a user. For example, client device 102 may be a mobile device, a tablet, a desktop computer, a set-top box, a streaming player, or any computing system capable of receiving, rendering, and presenting video data to the user. Users may include, but are not limited to, individuals such as, for example, subscribers, clients, prospective clients, entities, or customers of an entity associated with back-end computing system 104, such as individuals who have obtained, will obtain, or may obtain a product, service, or consultation from an entity associated with back-end computing system 104.

Client device 102 may include at least application 108. Application 108 may be representative of a web browser that allows access to a website or a stand-alone application. Client device 102 may access application 108 to access one or more functionalities of back-end computing system 104. Client device 102 may communicate over network 105 to request a webpage, for example, from web client application server 114 of back-end computing system 104. For example, client device 102 may be configured to execute application 108 to access forecasts and/or reports regarding a user's account, as generated by back-end computing system 104. The content that is displayed to client device 102 may be transmitted from web client application server 114 to client device 102, and subsequently processed by application 108 for display via a graphical user interface (GUI).

Back-end computing system 104 may include web client application server 114, machine learning platform 116, application programming interface (API) module 118, and interface module 120. Each of machine learning platform 116, API module 118, and interface module 120 may be comprised of one or more software modules. The one or more software modules may be collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

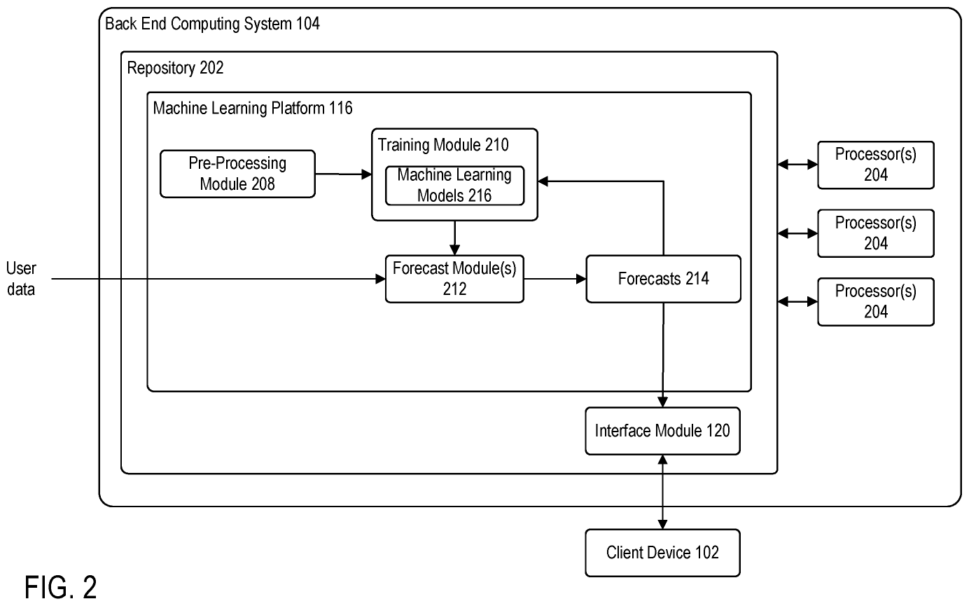

Machine learning platform 116 may be configured to generate forecasts for a user account using one or more machine learning techniques. The details of machine learning platform 116 may be found below in conjunction with FIG. 2.

API module 118 may be configured to allow for communication between back-end computing system 104 and one or more third-party systems 106. For example, API module 118 may include a set of APIs, each API dedicated to a specific third-party system. Each API may be configured to facilitate communication between back-end computing system 104 and a respective third-party system 106 in accordance with various formats as defined by each respective third-party system 106. Via API module 118, back-end computing system 104 may dynamically receive or retrieve daily financial data (e.g., cash balance, inflow data, outflow data, etc.) from one or more third-party systems 106 for use with machine learning platform 116.

Interface module 120 may be configured to generate one or more graphical user interfaces for display via client device 102. For example, following an inflow, outflow, and cash balance forecast, interface module 120 may generate a GUI that includes the various forecast data. In some embodiments, interface module 120 may transmit the GUIs to client device 102 for rendering and display thereon. In some embodiments, interface module 120 may render GUI at back-end computing system 104. In such embodiments, interface module 120 may transmit the rendered GUI to client device 102 for display thereon.

Third-party systems 106 may be representative of various financial institutions, customer enterprise resource planning services, treasury management systems, customer relationship management services associated with one or more accounts of a user of client device 102, third-party account aggregators, and/or financial messaging services. Exemplary third-party systems may include, but are not limited to, SAP, NetSuite, SAGE, Intuit QuickBooks, Microsoft Dynamics, Kyriba, Plaid, Yodlee, SWIFT, Citi Bank, Wells Fargo, USAA, and the like.

FIG. 2 is a block diagram illustrating back-end computing system 104, according to one or more embodiments disclosed herein. As shown in the illustrated example, back-end computing system 104 includes a repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least machine learning platform 116.

Machine learning platform 116 may be configured to forecast various metrics or variables associated with a user's account, with multiple accounts associated with a user and/or with the account(s) associated with multiple users. As noted above, users may refer to any number or type of clients, entities, etc. For example, machine learning platform 116 may be configured to forecast future inflow data and future outflow data for a user's account using one or more machine learning processes. In other embodiments, the machine learning platform 116 may be configured to forecast recurring events (e.g., transactions), deterministic variables (e.g., day of week, day of month, etc. of certain events), purpose(s) of events or transactions, event counter-parties, etc. As shown, machine learning platform 116 includes pre-processing module 208, training module 210, and forecast modules 212. Each of pre-processing module 208 and training module 210 may be comprised of one or more software modules. The one or more software modules are collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Pre-processing module 208 may be configured to gather data from among one or more accounts for training module 210. In some embodiments, pre-processing module 208 is configured to communicate with one or more third-party systems 106 and/or internal databases to retrieve data relevant for training, validating and/or testing. Exemplary training data, validation data and/or testing data may include historical data, such as historical cash position information (e.g., daily or intraday user account data), historical accounts receivable data, historical accounts payable data, historical order book data, and the like. This historical data may comprise any number of historical data points pertaining to one or more accounts associated with one or more users. In some embodiments, the pre-processing module 208 may gather the historical data for a predetermined historical period, such as at least 270 days, for example. In this example, the predetermined historical period may include a historical look-back period of 180 days and a historical look-forward period of 90 days. As discussed further below, the historical look-back and look-forward periods may be utilized to train, validate and test a machine learning model 216. In some embodiments, the predetermined period (and/or any portion thereof) may be customized to be longer or shorter according to the particular implementation.

In some embodiments, pre-processing module 208 may further be configured to perform one or more data imputation functions. Data imputation functions may include, without limit, identifying data among the historical data having missing values, and replacing the missing values with system-generated imputed values. In some embodiments, the system-generated imputed values may equal “0”. For example, if a particular day within the historical data has no events or values, the pre-processing module 208 may replace the missing (or null) value with a zero.

In some embodiments, data imputation functions may further include data filtering functions. Data filtering functions may include, without limit, identifying accounts from among the one or more accounts that do not have historical activity for an entirety of the predetermined look-back period, and removing those accounts from the historical data. For example, if the predetermined period comprises 270 days, accounts having fewer than 270 days of historical data may be removed from the historical data.

In some embodiments, pre-processing module 208 may further be configured to perform feature engineering functions. Feature engineering functions may include, without limit, augmenting the historical data with data indicative of attributes of the historical data. This may include, for example, capturing, identifying, labeling (e.g., usual, unusual, seasonal, etc.) and/or aggregating recurring events or transactions (e.g., rent payments, loan payments, one-time loan funds, and the like), frequency and/or length of time between events or transactions (e.g., periodicity), types of events or transactions (e.g., debit, credit, etc.), values of events or transactions, types of accounts, purpose of accounts, etc., and capturing and/or determining additional exogenous inputs (e.g., deterministic features) such as calendar data (e.g., current or prior weekday number (e.g., 1, 2, 3, 4, 5, 6, 7), current or prior month number (e.g., 1, 2, 3, 4, . . . 12), day of month number (e.g., 1, 2, 3, 4, . . . 31), etc.), whether the following day is a holiday or weekend, and the like.

In some embodiments, pre-processing module 208 may further be configured to perform data scaling functions to capture, for example, the relative movements and/or activity across the one or more accounts. Data scaling functions may include, without limit, mapping data values associated with the one or more accounts included in the historical data to a same output range. In some embodiments, the data scaling functions may be performed according to a cumulative scaler function by a cumulative scaler (not shown) that may be a part of or independent from the pre-processing module 208. In such embodiments, the scaling functions may map the data values to a min-max scale of between, for example, 0 and 1. In some embodiments, the scaling functions may be applied to the historical data on a per-predetermined historical period basis (e.g., to data within each 270 day window comprising predetermined historical period).

In some embodiments, pre-processing module 208 may capture user expectation data. Exemplary expectation inputs may include, but are not limited to, future cash receivables (e.g., future accounts receivables) and future cash payables (e.g., future accounts payables).

In some embodiments, pre-processing module 208 may further be configured to split the historical data (e.g., the historical data points) from among one or more accounts into a training data set, a validation data set and a test data set, each of which may be scaled based on the split. For example, the historical data from among the one or more accounts may be split into a first group comprising a first portion of the historical data, a second group comprising a second portion of the historical data and a third group comprising a third portion of the historical data. The historical data points in each of the first, second and third groups may be sequenced chronologically, such that none of the historical data points in any of the groups overlaps (i.e., each historical data point belongs to only one group), and within each group, all historical data points are sequenced chronologically. For instance, if the historical data comprises historical data points from the year 2016 through and including the year 2021, the first group of the historical data may comprise all historical data points from 2016 through 2018; the second group may comprise the historical data points from 2019 through 2020; and the third group may comprise the historical data points from the year 2020. In this example, the first group (e.g., from 2016-2018) may comprise the training data set, the second group (e.g., from 2019-2020) may comprise the validation data set, and the third group (e.g., from 2021) may comprise the test data set.

In some embodiments, the historical data may be scaled according to the determined split. Thus, continuing with the illustrative example provided above, the first group of historical data (e.g., training data set) may be scaled based on the historical data points from 2016-2018. The second group of historical data (e.g., validation data set) may be scaled based on the historical data points from 2016-2020, which includes the entire training data set and the validation data set. And the third group of historical data (e.g., test data set) may be scaled based on the historical data points from 2016-2021, which includes the entire training data set, the entire validation data set and the entire test data set.

In some embodiments, the training data set and the validation data set are utilized during training of the machine learning model 216 (discussed below), whereas the test data set may be utilized to test the machine learning model 216 once training is completed (but before the machine learning model 216 is deployed). In some embodiments, the test data set may be referred to as an out-of-time data set, since it is not used to directly train the machine learning model 216. In some embodiments, the historical data may also include an out-of-sample data set that may be utilized to evaluate generalizability of the machine learning model 216. For example, the out-of-sample data set may include a portion of the historical data that was not included in the training data set, the validation data set or the test data set. Then, once the machine learning model 216 is trained, validated and tested (e.g., via the training data set, validation data set and test data set, respectively), the machine learning model may be evaluated as to its performance in view of the out-of-sample data set. As indicated above, this type of evaluation may indicate the generalizability of the machine learning model 216 (e.g., ability of model to generate forecasts for accounts without having been trained, validated or tested with historical data from such accounts).

Training module 210 may be configured to train machine learning model 216 to generate a personalized future inflow data forecasts and future outflow data forecasts based at least on various information associated with the user, one or more accounts associated with the user, and one or more accounts associated with multiple users. In some embodiments, training module 210 may further train machine learning model 216 to generate a balance forecast based on the inflow forecast, the outflow forecast, and the known end-of-day balance from the prior day. In some embodiments, the training process may be a supervised training process. For example, the training data set of historical inflow and outflow data may also include the corresponding known forecast information. During the training process, parameters of the machine learning model 216 may be adjusted in order to optimize (e.g., minimize) the value of an objective function (e.g., loss functions). In some embodiments, the parameters may be changed automatically by training module 210. In some embodiments, the parameters may be changed manually by an operator or developer.

The objective function of machine learning model 216 may be used to penalize errors not only for inflow and outflow forecasts, but also for their difference, which may correspond to a change in balance. By penalizing errors in the balance forecast, training module 210 may reduce the drift of the forecasted value from the actual balance.

In some embodiments, the objective function may be composed of a sum of various components: an inflow component, an outflow component, and a difference component (i.e., a change in balance). In some embodiments, the objective function may further include a weight parameter. The weight parameter may provide for a tradeoff between inflow/outflow prediction errors and the balance prediction errors. In other words, by adjusting the weight parameter, the objective function may be optimized for improving the balance forecast accuracy at the expense of a slightly less accurate inflow/outflow forecast.

In some embodiments, training module 210 may train machine learning model 216 to generate a single day's forecast. In some embodiments, training module 210 may train machine learning model 216 to forecast a longer horizon, i.e., more than a single day's forecast. For example, training module 210 may utilize forecasted values, as well as historical inflow and outflow data, to train machine learning model 216 to generate forecasts beyond a single day.

In some embodiments, training module 210 may train machine learning model 216 on a data set dedicated to the target user. For example, training module 210 may train a user specific machine learning model 216 based on historical inflow and outflow data corresponding to the particular individual or entity. In some embodiments, training module 210 may train machine learning model 216 across various users and/or accounts. Such training process may be useful when entities or users exhibit similar activity patterns. As such, training module 210 may train machine learning model 216 on user specific data, as well as user data associated with other users that have similar characteristics, demographics, and/or financials to the target user.

In some embodiments, machine learning model 216 may be representative of a recurrent neural network. A recurrent neural network may be composed of a sequence of identical cells. Each cell may receive, as input, new daily information (e.g., inflow activity, outflow activity, previous end-of-day balance) and hidden states from previous cells. Based on the new daily information and hidden states from previous cells, the recurrent neural network may calculate a weighted sum and propagate forward to the next day. As output, recurrent neural network may generate a forecast.

For a recurrent neural network, a combination of forward propagation and back propagation may be used for training. During forward propagation, recurrent neural network may receive a sequence of data, calculate a forecast, compare the forecast to actual data, and then calculate the error between the forecasted value and the actual value. During back propagation, one or more weights of the recurrent neural network may be updated to reduce or minimize the error calculated during forward propagation.

In some embodiments, recurrent neural network may include multiple layers, in which the daily input and previous day's hidden cells may be used to compute outputs. The outputs may then be fed into another layer with its own hidden cells. This process may be repeated until a final output is generated that may be used for the forecast.

In some embodiments, machine learning model 216 may be representative of a long short-term memory (LSTM). A LSTM model is a specific artificial recurrent neural network architecture capable of learning long term dependencies. LSTM model may learn to capture and/or determine multiple periodic patterns in a user's or client's data, such as weekly, semi-weekly, monthly, and the like. In some embodiments, using an LSTM model may allow machine learning platform 116 to model inflow, outflow, balance and/or any number of other variables together in a combined model, for any number of time steps, and for any number of users, all at once. In some embodiments, the LSTM model may comprise a many-to-many encoder-decoder LSTM recurrent neural network model configured to run (e.g., generate multi-step time series forecasts) as a daily batch process. The encoder features of such an LSTM model may be configured to project (e.g., condense) high dimension representation(s) of all input data (e.g., historical data, imputed data, feature engineering data, etc.) to a lower dimension vector subspace(s), while retaining important information, context, global meaning, etc. of the data. The decoder features of such an LSTM model may be configured to utilize the data which is now in a lower dimension vector subspace (e.g., from the encoder feature), as well as current input data (e.g., current day data), to produce predictions/forecasts. The objective function may then be used to evaluate the predictions/forecasts, and if needed, model weights of the objective function may be adjusted based on the evaluation.

In an illustrative example, the training module 210 may be configured to train, validate and/or test machine learning model 216 based on a training data set, a validation data set and a test data set provided by the pre-processing module 208. As discussed above, the training data set, the validation data set and the test data set may be generated by splitting historical data from one or more accounts associated with one or more users. Prior to splitting, the historical data may be pre-processed, which may include data imputation, data filtering, feature engineering and/or data scaling functions. Once pre-processed, the historical data may be split to generate a training data set, a validation data set and a test data set.

In some embodiments, the training module 210 may include a model training data generator (now shown) to feed the training data set, as input sequences, to the training module 210. The model training data generator may further be configured to introduce randomness into the order of the input sequences, so as the machine learning model 216 may learn in a generalizable and robust manner. In some embodiments, the training data set may be introduced into the training module 210 using a stratified sampling process. Using a stratified sampling process may be used to address instances where there are more sequences of low activity (e.g., limited events or transactions within a time sequence) within the training data set than sequences of high activity. In some embodiments, the stratified sampling process may include splitting, by the model training data generator, the training data set into activity level buckets, and pulling an equal size of samples from each activity level bucket. The samples may then be fed into the training module 210. In this manner, an equivalent number of high activity and low activity sequences will be used to train the machine learning model 216, which improves performance and accuracy of the machine learning model 216.

During the training process, an accuracy of predictions generated by the machine learning model 216 may be evaluated based on the validation data set, and based on the evaluation, one or more parameters (e.g., weight parameter) of the machine learning model 216 may be adjusted in order to optimize (e.g., minimize) the value of an objective function (e.g., loss functions). In some embodiments, the parameters may be changed automatically by training module 210. In some embodiments, the parameters may be changed manually by an operator or developer.

In some embodiments, the objective function may be composed of a sum of various components: an inflow component, an outflow component, a difference component (i.e., a change in balance), etc., and in some embodiments, the objective function may further include a weight parameter, as noted above. The weight parameter may provide for a tradeoff between inflow/outflow prediction errors and the balance prediction errors. In other words, by adjusting the weight parameter, the objective function may be optimized for improving the balance forecast accuracy at the expense of a slightly less accurate inflow/outflow forecast.

Once the training module 210 trains and validates machine learning model 216 to an acceptable convergence, the training process may be completed. The training module 210 may then test a performance of machine learning model 216 based on the test data set. That is, an accuracy of predictions generated by the trained and validated machine learning model 216 may be determined in view of the test data set. Once an acceptable level of performance is obtained, the now trained, validated and tested machine learning model 216 may be selected for deployment via one or more forecast modules 212 (discussed below).

In some embodiments, the training module 210 may train, validate and test multiple machine learning models 216 (e.g., using a variety of hyperparameter combinations), and the best performing model among the machine learning models 216 may be selected for deployment.

Deployment of the machine learning model(s) 216, in some embodiments, may include loading the selected machine learning model(s) 216 with input data, and deploying the model(s) 216 into production through top-level program files (e.g., cloud-based scripts), which may be run as a batch process. In some embodiments, the batch process may comprise a daily batch process, which may include capturing (e.g., taking in) each day's new set(s) of data, processing the new daily set(s) of data and then generating forecast outputs by inputting the processed daily set(s) of data into the selected machine learning model(s) 216. These forecast outputs may then be saved in tables (e.g., in a cloud environment), which may then be accessed and displayed by an interactive GUI that is generated by the interface module 120 (discussed further below).

Once the machine learning model(s) 216 are deployed, the forecast module 212 may be configured to generate forecasts (e.g., future inflow data, future outflow data, future balance data, etc., as discussed above)) for any number of entities for any multi-step time horizon (e.g., 30 days, 90 days, etc.), all at once.

Although recurrent neural network models and LSTM models are discussed as being two exemplary types of models for use in machine learning platform 116, those skilled in the art understand that machine learning model 216 may not be limited to such models. Instead, additional machine learning models may be used. Exemplary machine learning models or algorithms may include, but are not limited to, random forest model, support vector machines, neural networks, deep learning models, Bayesian algorithms, Temporal Convolutional Networks, and the like.

Following training, training module 210 may generate one or more forecast modules 212. In some embodiments, training may comprise training and validating the machine learning model 216. In such embodiments, the machine learning model 216 may be tested (e.g., using a test data set) following training, but before generating the one or more forecast modules 212. In some embodiments, a machine learning model 216 that has been trained, validated, tested, selected and deployed (e.g., running in production) may be referred to as a forecast module 212.

In some embodiments, one or more forecast modules 212 may be used across a user base. For example, a given forecast module 212 may be trained or optimized for more than one user and for one or more accounts associated with users in the user base. In some embodiments, one or more forecast modules 212 may be representative of a plurality of uniquely trained forecast modules 212, with each forecast module 212 corresponding to a dedicated user or a dedicated account. In some embodiments, each such forecast module 212 may operate one-at-a-time to generate forecasts for in-scope accounts associated with a user base. Operation of a subsequent forecast module 212 (e.g., for a different user base and/or a different set of in-scope accounts) may comprise iteratively updating and/or revamping a prior forecast module 212, which itself may include acquiring new data set(s), training, validating testing, etc. one or more machine learning model(s) 216, etc., as discussed above.

In operation, one or more forecast modules 212 may be deployed to generate one or more forecasts 214 that include various metrics associated with the user's account, with multiple accounts associated with the user and/or with accounts associated with multiple users. For example, forecasts 214 may be representative of a future inflow forecast, a future outflow forecast, and a future balance forecast. As shown and described above, forecasts 214 may be fed back into training module 210 for continuous or future learning. In some embodiments, training module 210 may train (or re-train) a future machine learning model 216 with new data that was not previously available and/or with new input features or columns that were not present in prior iterations of the machine learning model 216.

Although trained by training module 210, machine learning platform 116 may support a self-training process. For example, the process flow may be a closed looped process, in which training module 210 may continuously or periodically update one or more forecast modules 212 by retraining machine learning model 216, generating new weights, and creating updated forecast based on the new weights. In some embodiments, retraining machine learning model 216 may include evaluating model performance over time using an accuracy or error metric. In some embodiments, machine learning platform 116 may be retrained on a periodic basis. In some embodiments, this evaluation process may be automatic. In some embodiments, machine learning model 216 may be retrained on an ongoing basis.

In some embodiments, the back end computing system 104 may comprise a model performance modeling module (not shown) configured to evaluate a performance of the machine learning model 216 over time. As noted above, the evaluation process may be automatic, ongoing and/or initiated periodically. In some embodiments, the performance modeling module may be further configured to determine whether the machine learning model 216 is degrading over time by evaluating the performance in view of one or more predefined metrics. If one or more among the predefined metric(s) falls below a predefined threshold and/or demonstrates a performance trend indicative of degrading performance, a retraining and/or recalibration of the machine learning model 216 may be initiated.

Once trained, one or more forecast modules 212 may be deployed within machine learning platform 116. Forecast module 212 may receive, as input, various data related to the user's account(s) and/or related to the account(s) of multiple users. In some embodiments, forecast module 212 may receive daily or intraday data related to the user's/users' account(s). Exemplary daily or intraday data may include information related to the user's/users' financial accounts, such as, but not limited to, checking accounts, savings accounts, and the like. In some embodiments, forecast module 212 may receive the daily or intraday data via API module 118. For example, API module 118 may leverage one or more APIs associated with the user's financial institutions for pulling or receiving account data on a daily or intraday basis. Such information may provide forecast module 212 with the user's cash positions during the day and/or at the end of the day.

In some embodiments, forecast module 212 may receive, as input, enterprise resource planning (ERP) data. For example, forecast module 212 may receive various data from one or more customer ERP systems. Exemplary ERP data may include, but is not limited to accounts receivable data, accounts payable data, and/or client order book information. In some embodiments, forecast module 212 may receive the ERP data via API module 118. For example, API module 118 may leverage one or more APIs associated with the user's ERP systems for pulling or receiving account data on a real-time or near real-time basis.

In some embodiments, forecast module 212 may receive, as input, historical data associated with the user(s). In some embodiments, the historical data associated with the user(s) may be in the form of a Bank Administration Institute (BAI) file. In some embodiments, forecast module 212 may receive the user's/users' historical data via API module 118. For example, API module 118 may leverage one or more APIs associated with the user's/users' financial intuitions for pulling or receiving the user's/users' historical data. Because of the nature of historical data, API module 118 may only need to request this information once.

Based on the daily/intraday account data, the ERP data, and the historical data, forecast module 212 may project or forecast future cash flow for the user(s). In some embodiments, the input data (e.g., daily/intraday account data, the ERP data, the historical data, etc.) may be pre-processed prior to modeling. That is, the preprocessing module 208 may be further configured to perform data imputation, featuring engineering, and/or data scaling functions on the input data before the input data is provided to the forecast module 212 for generating forecasts or predictions. In some embodiments, forecast module 212 may project or forecast future inflow. In some embodiments, forecast module 212 may project or forecast future outflow. In some embodiments, forecast module 212 may project or forecast future balance data (e.g., based on forecasted future inflow and forecasted future outflow). In this manner, forecast module 212 may provide users with actionable insights related to their financial health.

Interface module 120 may generate a graphical representation of the forecasted data for display via client device 102. For example, following an inflow, outflow, and cash balance forecast, interface module 120 may generate a GUI that includes the various forecast data. In some embodiments, interface module 120 may transmit the GUIs to client device 102 for rendering and display thereon. In some embodiments, interface module 120 may render GUI at back-end computing system 104. In such embodiments, interface module 120 may transmit the rendered GUI to client device 102 for display thereon.

Although FIG. 2 is discussed in conjunction with machine learning platform 116 and forecast module 212 being remote from client device 102, it should be understood that training and/or deployment of machine learning platform 116 may be performed local to client device 102. For example, the foregoing techniques may be used in a browser (e.g., application 108) using machine learning libraries such as, for example, tensorflow.js, or using a graphics processing unit (GPU) of client device 102 using graphics libraries such as, for example, WebGL. Following training, machine learning platform 116 may be deployed within the browser.

In some embodiments, depending on the complexity of machine learning platform 116 implementation, forecast module 212 may be trained on back-end computing system 104 and deployed locally via application 108. For example, the foregoing techniques may utilize a knowledge distillation process, in which a larger, complex model is trained using the above techniques and the knowledge used from training the larger, complex model is distilled to a smaller, lightweight model that is capable of being deployed locally via application 108 on client device 102.

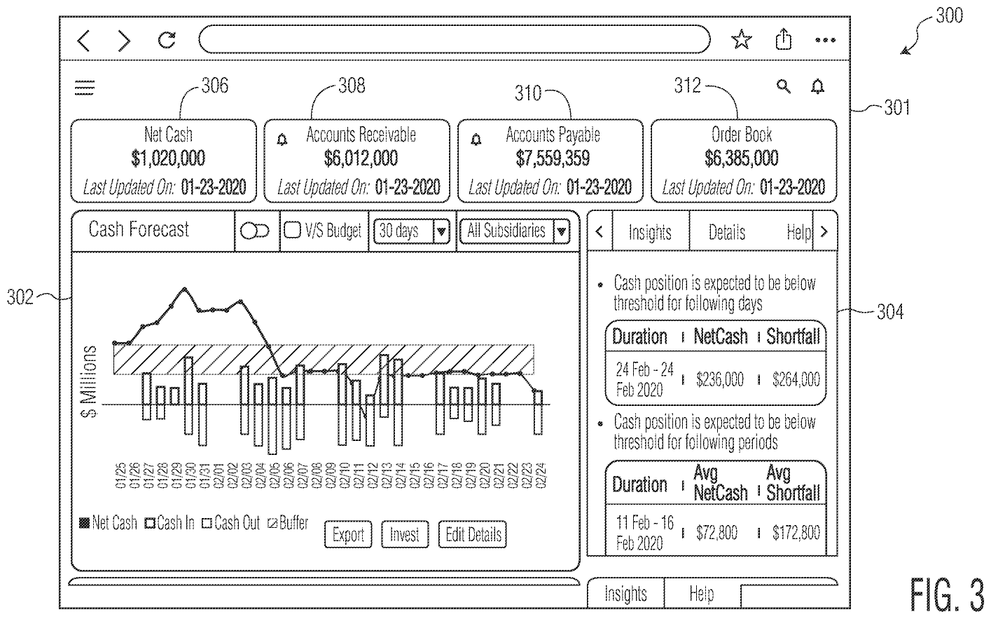

FIG. 3 illustrates an exemplary graphical user interface (GUI) 300 generated by interface module 120, according to example embodiments. Graphical user interface (hereinafter “GUI 300”) may correspond to a GUI generated by interface module 120. In some embodiments, GUI 300 may be a web page presented in a web browser application (e.g., application 108) of client device 102. In some embodiments, GUI 300 may be a graphical user interface generated by a native software application (e.g., application 108) executing on client device 102.

GUI 300 may include a dashboard 301. Dashboard 301 may provide users with a snapshot of their cashflow, as well as a cash forecast and generated insights. Dashboard 301 may include a cash forecast 302 and insights 304. Cash forecast 302 may be generated by forecast module 212. Cash forecast 302 may include an inflow data forecast, an outflow data forecast, and a balance forecast. As shown, cash forecast 302 may span a time frame as defined by the user. In the present example, cash forecast 302 may represent a 30-day cash forecast.

Insights 304 may correspond to various insights generated by forecast module 212. Forecast module 212 may generate insights 304 based on the generated cash forecast. In some embodiments, insights 304 may take the form of notifications or alerts. For example, as shown, insights 304 may include information related to the user's cash position during defined periods of time.

In some embodiments, dashboard 301 may further include a snapshot of the user's current cash position. For example, as shown, dashboard 301 may include a net cash element 306, an accounts receivable element 308, an accounts payable element 310, and an order book element 312. Net cash element 306 may represent the user's current net cash position, e.g., balance. In some embodiments, the user's current net cash position may be generated based on daily or intraday information from the user's financial accounts. Accounts receivable element 308 may represent the user's current account receivables. Accounts payable element 310 may represent the user's current account payable information. Order book element 312 may represent the user's current order book information. In some embodiments, each of the user's current account receivables, current account payables, and order book information may be generated in real-time or near-real time based on data received or retrieved from one or more third-party systems 106.

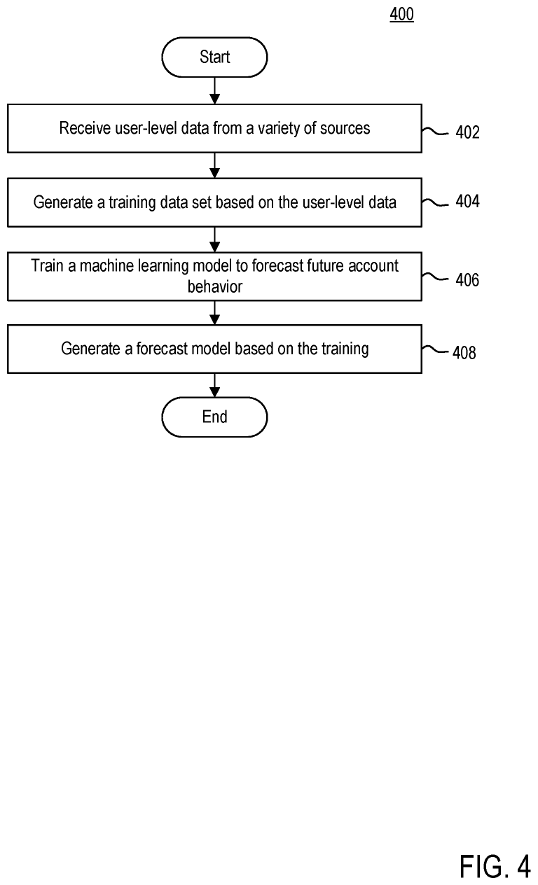

FIG. 4 is a flow diagram illustrating a method 400 of generating a forecast module, according to example embodiments. As shown, method 400 may begin at step 402.

At step 402, back-end computing system 104 may receive (or retrieve) user-level data from a variety of data sources. For example, machine learning platform 116 may communicate with one or more third-party systems 106 and/or internal databases to access user-level data. Exemplary user-level data may include historical cash position information (e.g., daily or intraday user account data), historical accounts receivable data, historical accounts payable data, historical order book data, and the like. In some embodiments, machine learning platform 116 may communicate with one or more third-party systems 106 via API module 118. For example, API module 118 may access user-level data from one or more third-party systems 106 via one or more APIs linking one or more third-party system 106 to back-end computing system 104. In some embodiments, each API may be dedicated to a specific third-party system 106.

In some embodiments, back-end computing system 104 may retrieve user-level data for a single user. In some embodiments, back-end computing system 104 may retrieve user-level data for a plurality of users.

At step 404, back-end computing system 104 may generate training data based on the user-level data. For example, pre-processing module 208 may format or convert the user-level data into a format compatible with training module 210 and/or machine learning model 216. In some embodiments, formatting the user-level data may include anonymizing the user-level data to protect any sensitive information that may be contained in the user-level data.

In some embodiments, generating the training data set may include pre-processing module 208 deriving additional data from the user-level information. For example, pre-processing module 208 derive a transaction type for various transactions included in the user-level data. Exemplary transaction type inputs may include, but are not limited to, rent payments, loan payments, one-time loan funds, and the like. These transactions may be further classified as usual and/or unusual payments.

In some embodiments, generating the training data set may include pre-processing module 208 augmenting the user-level data with context related to the user-level data. For example, based on the user-level data, pre-processing module 208 may derive exogenous inputs, such as, but not limited to, calendar data, such as current weekday number and whether the following day is a holiday, for each input data element.

In some embodiments, generating the training data set may include providing corresponding forecasts to the user-level data. For example, if training module 210 is implementing a supervised training process, the training data set may include historical inflow information, historical outflow information, historical balance information, and may also include a corresponding known forecast information based on snapshots of the historical data.

In some embodiments, generating the training data set may include pre-processing module 208 clustering the user base. For example, rather than training module 210 train machine learning model 216 on user-specific data, training module 210 may train machine learning model 216 on user-specific data and other user data, where the other user data corresponds to users that are demographically similar to the target user. Using a specific example, if the target user is a female engineer, in California, with two children, training module 210 may identify user-level data for other female engineers living in California with two children. Using another example, if the target user is an organization or company, training module 210 may identify organization-level data for organizations that have similar characteristics as the target organization (e.g., FinTech organization, semiconductor manufacturing organization, organizations with less than 100 employees in Oregon, restaurants of a certain size in a certain location, etc.). Using a broader example, training module 210 may identify user-level data for other engineers living in California.

At step 406, back-end computing system 104 may train machine learning model 216 to forecast future account behavior based on the training data set. For example, training module 210 may train machine learning model 216 to generate a personalized future inflow data forecasts, future outflow data forecasts, and future balance forecasts based on the training data set. In some embodiments, training module 210 may further train machine learning model 216 to generate a balance forecast based on the inflow forecast, the outflow forecast, and the known end-of-day balance from the prior day. In some embodiments, the training process may be a supervised training process. During the training process, parameters of the machine learning model 216 may be adjusted in order to optimize (e.g., minimize) the value of an objective function (e.g., loss functions). In some embodiments, the parameters may be changed automatically by training module 210. In some embodiments, the parameters may be changed manually by an operator or developer.

In some embodiments, machine learning model 216 may be optimized for a single user. In such embodiments, the training may be performed for each user in the user base. In some embodiments, machine learning models 216 may be optimized for a group of users that includes a target user.

At step 408, back-end computing system 104 may generate a forecast module based on the training. For example, once training module 210 trains machine learning model 216 to an acceptable convergence (as specified by an operator), back-end computing system 104 may deploy forecast module 212 within machine learning platform 116. Once deployed, forecast module 212 may be configured to forecast future inflow data, future outflow data, and future balance data.

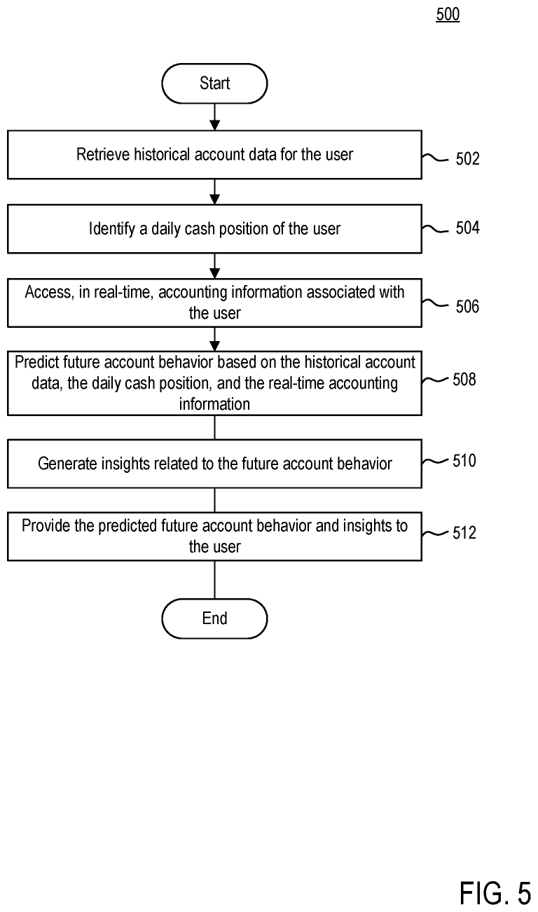

FIG. 5 is a flow diagram illustrating a method 500 of generating user forecasts, according to example embodiments. Method 500 may begin at step 502.

At step 502, back-end computing system 104 may retrieve historical account data for a target user. In some embodiments, the historical data associated with the user may be in the form of a BAI (Bank Administration Institute) file. In some embodiments, forecast module 212 may receive the user's historical data via API module 118. For example, API module 118 may leverage one or more APIs associated with the user's financial intuitions for pulling or receiving the user's historical data.

At step 504, back-end computing system 104 may identify a daily cash position of the user. For example, forecast module 212 may receive daily or intraday data related to the user's accounts. Exemplary daily or intraday data may include information related to the user's financial accounts, such as, but not limited to, checking accounts, savings accounts, and the like. In some embodiments, forecast module 212 may receive the daily or intraday data via API module 118. For example, API module 118 may leverage one or more APIs associated with the user's financial institutions for pulling or receiving account data on a daily or intraday basis. Such information may provide forecast module 212 with the user's cash positions during the day and/or at the end of the day.

At step 506, back-end computing system 104 may access, in real-time or near real-time, accounting information associated with the user. For example, forecast module 212 may receive various data from one or more customer ERP systems. Exemplary ERP data may include, but is not limited to accounts receivable data, accounts payable data, and/or client order book information. In some embodiments, forecast module 212 may receive the ERP data via API module 118. For example, API module 118 may leverage one or more APIs associated with the user's ERP systems for pulling or receiving account data on a real-time or near real-time basis.

At step 508, back-end computing system 104 may predict or forecast future account behavior based on one or more of the historical account data, the daily cash position, and the accounting data. In some embodiments, forecast module 212 may forecast a future inflow data and a future outflow data based on one or more of the historical account data, the daily cash position, and the accounting data. In some embodiments, forecast module 212 may further construe a forecast account balance based on the forecasted future inflow, the forecasted future outflow, and the current balance information.

At step 510, back-end computing system 104 may generate insights related to the future account behavior. For example, based on the forecasted future inflow information, the forecasted future outflow information, and/or the forecasted account balance, forecast module 212 may generate alerts or insights related to the user's cash position.

At step 512, back-end computing system 104 may provide the predicted future account behavior and generated insights to the user. For example, interface module 120 may generate an interactive user interface that allows a user to view the forecasts and insights (e.g., recommendations) via application 108.

A system according to exemplary embodiments described herein may be configured for generating multi-variable, multi-entity and multi-step time series forecasts, for any length time horizon, all at once. The exemplary system may comprise one or more processors and a memory storing programming instructions that, when executed by the one or more processors, cause the system to generate, deploy and/or execute one or more of the features and/or operations described herein. In operation, the system may retrieve historical account activity data for a plurality of accounts associated with one or more users. In some embodiments, the plurality of accounts may be associated with multiple users. The historical account activity data retrieved may include historical data points arranged in chronological order for a predetermined number of days (e.g., historical data points for each of 270 consecutive days), including (among others) historical inflow data and historical outflow data.

The system may then be configured to pre-process the historical account activity data. In some embodiments, pre-processing may include a combination of data imputation, data filtering, feature engineering and/or data scaling. In some embodiments, data imputation may comprise identifying data among the historical account activity data having missing values, and replacing the missing values with system-generated imputed values. Data filtering may include identifying accounts from among the plurality of accounts that do not have activity data for at least a predetermined number of days (e.g., 270 days, where 180 days comprise a look-back period and 90 days comprise a look-forward period), and removing the activity data associated with the identified accounts from the historical account activity data. Feature engineering may include augmenting the historical account activity data with data indicative of attributes of the historical account activity data, such as of type, value, frequency, purpose, periodicity, day (e.g., of week, of month, etc.), date, etc. of the historical account activity data. Data scaling may include mapping data values associated with each of the plurality of accounts to a same output range according to a cumulative scaler function. In some embodiments, the data scaling may map the data values to a min-max scale of between, for example, 0 and 1.

Once the historical account activity data is pre-processed, the system may proceed to construct a training data set based on the now pre-processed historical account activity data. In some embodiments, constructing the training data set may involve splitting the historical activity data points into at least three different groups: a first group comprising a first portion of the historical data points, a second group comprising a second portion of the historical data points and a third group comprising a third group of the historical data points. Since the historical account activity data may be arranged in chronological order, the historical data points in each group may also be in chronological order, and each group may have historical data points that do not overlap. Further, the historical data points in the second group may chronologically follow the historical data points in the first group, and the historical data points in the third group may chronologically follow the historical data points in the second group. To illustrate, if the retrieved historical activity data comprises historical data points from Jan. 1, 2016-Dec. 31, 2018, the first group of historical data points may include activity data from Jan. 1, 2016-Dec. 31, 2016; the second group may include activity data from Jan. 1, 2017-Dec. 31, 2017; and the third group may include activity data from Jan. 1, 2018-Dec. 31, 2018, for example. Further, the data points within each group may be arranged chronologically.

Once the historical activity data is split into groups, one of the groups (e.g., the first group) may comprise and be designated as a training data set, another group (e.g., the second group) may comprise/be designated as a validation data set and another group (e.g., the third group) may comprise a test data set (discussed further below).

The system may further be configured to generate and train a combined prediction model to forecast future inflow activity and future outflow activity for a multi-step time horizon. The multi-step time horizon may be any number of days, such as 2 days, 30 days, 60 days, 90 days or more, and the forecasts generated by the combined prediction model may include inflow forecasts for each day in the time horizon, outflow forecasts for each day in the time horizon, and balance forecasts for each day in the time horizon. Thus, if the time horizon is 90 days, the combined prediction model may be configured to generate inflow, outflow and balance forecasts (as well as other forecast variables) for each account for each day in the 90-day time horizon, all at once.

The system may be configured to train the combined prediction model based on the training data set. In some embodiments, the training data set may be fed into the combined prediction model, during the training, according to a stratified sampling process. Training the combined prediction model may include optimizing an objective function of the prediction model by adjusting at least one weight parameter of the objective function based on an accuracy of one or more predictions generated by the combined prediction model during its training. The predictions may include, for example, a combination of projected inflow predictions, projected outflow predictions and differences between the projected inflow predictions and the projected outflow predictions.

The accuracy of the prediction(s) generated during training may be assessed based on the validation data set, and the adjustment(s) to the weight parameter(s) may be initiated in view of such assessments. This process (e.g., assessing predictions, adjusting weight parameter(s)) may be repeated until the combined prediction model reaches an acceptable convergence, at which point training may be completed.

Upon completion of the training, the system may be configured to test the combined prediction model based on the test data set. In some embodiments, testing the trained (and validated) combined prediction model may also include evaluating the combined prediction model based on fourth portion of the historical data points that was not included in any of the first group, the second group and the third group. The historical data points in this fourth group may include, for example, historical activity data associated with one or more accounts that were excluded from the first group, second group and third group. As a result, the historical activity data in this fourth group was not used to train or validate the combined prediction model. As discussed above, testing the combined prediction model based on this fourth group of historical activity data enables the system to evaluate a generalizability of the combined prediction model.

Once testing of the combined prediction model is completed, the system may select the combined prediction model. The system may also receive (or retrieve), from one or more third-party systems, a combination of current inflow activity data, current outflow activity data, and current balance information associated with one or more target accounts. Each of the current inflow activity data, the current outflow activity data, and the current balance information may comprise a combination of historical account data, daily cash position data and accounting data. The current inflow activity data, current outflow activity data, and current balance information may comprise a multi-variable data set, and the combined prediction model may be configured to model the multi-variable data set to generate future inflow forecasts and future outflow forecasts for each target account.

In some embodiments, the system may be configured to perform further pre-processing operations on the current inflow activity data, the current outflow activity data, and the current balance information associated with the target account(s). The further pre-processing operations may include, for example, data imputation, feature engineering and data scaling.

The combined prediction model may be deployed to generate a future inflow forecast and a future outflow forecast for each of the one or more target accounts based on a combination of the current inflow activity data, the current outflow activity data, and the current balance information. As noted above, the future inflow forecast may include inflow forecasts for each of a plurality of time steps in the multi-step time horizon, and the future outflow forecast may include an outflow forecast for each of a plurality of time steps in the multi-step time horizon.

The system may then determine, based on the future inflow forecast and the future outflow forecast, a future balance forecast for the target account(s) that includes a balance forecast for each of a plurality of time steps in the multi-step time horizon. In some embodiments, the combined prediction model may be configured to generate future inflow forecasts, future outflow forecasts and future balance forecasts all at once.

In some embodiments, the system may further be configured to retrain the combined prediction model. The retraining may include, for example, evaluating (e.g., over a predetermined period of time) a performance of the combined prediction model based on one or more performance metrics, determining whether at least one of the performance metrics falls below a predetermined threshold based on the evaluating, adjusting the at least one weight parameter based on said determining, and optimizing the objective function based on the adjusted at least one weight parameter.

In some embodiments, the system is further configured to store one or more of the future inflow forecast, the future outflow forecast and the future balance forecast in one or more tables for future access and retrieval.

In some embodiments, the system may further be configured to generate a graphical user interface (GUI) that displays one or more of the future inflow forecast, the future outflow forecast and the future balance forecast. In some embodiments, the system may be configured transmit the GUI to one or more user devices for rendering and display thereon; while in some embodiments, the system may be configured to render the GUI at said system, and then transmit the rendered GUI to one or more client devices for display thereon.

A method according to the present disclosure may be executed by a system according to exemplary embodiments described herein. The method may include generating multi-variable, multi-entity and multi-step time series forecasts, for any length time horizon, all at once. The exemplary method may be implemented by a system comprising one or more processors and a memory storing programming instructions that, when executed by the one or more processors, cause the system to generate, deploy and/or execute one or more of the features and/or operations described herein.

The method may include retrieving historical account activity data for a plurality of accounts associated with one or more users. In some embodiments, the plurality of accounts may be associated with multiple users. The historical account activity data retrieved may include historical data points arranged in chronological order for a predetermined number of days (e.g., historical data points for each of 270 consecutive days), including (among others) historical inflow data and historical outflow data.

The method may then include pre-processing the historical account activity data. In some embodiments, pre-processing may include a combination of data imputation, data filtering, feature engineering and/or data scaling. In some embodiments, data imputation may comprise identifying data among the historical account activity data having missing values, and replacing the missing values with system-generated imputed values. Data filtering may include identifying accounts from among the plurality of accounts that do not have activity data for at least a predetermined number of days (e.g., 270 days, where 180 days comprise a look-back period and 90 days comprise a look-forward period), and removing the activity data associated with the identified accounts from the historical account activity data. Feature engineering may include augmenting the historical account activity data with data indicative of attributes of the historical account activity data, such as of type, value, frequency, purpose, periodicity, day (e.g., of week, of month, etc.), date, etc. of the historical account activity data. Data scaling may include mapping data values associated with each of the plurality of accounts to a same output range according to a cumulative scaler function. In some embodiments, the data scaling may involve mapping the data values to a min-max scale of between, for example, 0 and 1.

Once the historical account activity data is pre-processed, the method may proceed to constructing a training data set based on the now pre-processed historical account activity data. In some embodiments, constructing the training data set may involve splitting the historical activity data points into at least three different groups: a first group comprising a first portion of the historical data points, a second group comprising a second portion of the historical data points and a third group comprising a third group of the historical data points. Since the historical account activity data may be arranged in chronological order, the historical data points in each group may also be in chronological order, and each group may have historical data points that do not overlap. Further, the historical data points in the second group may chronologically follow the historical data points in the first group, and the historical data points in the third group may chronologically follow the historical data points in the second group.

Once the historical activity data is split into groups, one of the groups (e.g., the first group) may comprise and be designated as a training data set, another group (e.g., the second group) may comprise/be designated as a validation data set and another group (e.g., the third group) may comprise a test data set (discussed further below).

The method may further include generating and training a combined prediction model to forecast future inflow activity and future outflow activity for a multi-step time horizon. The multi-step time horizon may comprise any number of days, such as 2 days, 30 days, 60 days, 90 days or more, and the forecasts generated by the combined prediction model may include inflow forecasts for each day in the time horizon, outflow forecasts for each day in the time horizon, and balance forecasts for each day in the time horizon. Thus, if the time horizon is 90 days, the method may include generating, by the combined prediction model, inflow, outflow and balance forecasts (as well as other forecast variables) for each account for each day in the 90-day time horizon, all at once.

The method may include training the combined prediction model based on the training data set. In some embodiments, the method may include feeding the training data set into the combined prediction model, during the training, according to a stratified sampling process. Training the combined prediction model may include optimizing an objective function of the prediction model by adjusting at least one weight parameter of the objective function based on an accuracy of one or more predictions generated by the combined prediction model during its training. The predictions may include, for example, a combination of projected inflow predictions, projected outflow predictions and differences between the projected inflow predictions and the projected outflow predictions.

The method may also include assessing the accuracy of the prediction(s) generated during training based on the validation data set, and adjusting the weight parameter(s) in view of such assessments (e.g., based on the validation data set). This process (e.g., assessing predictions, adjusting weight parameter(s)) may be repeated until the combined prediction model reaches an acceptable convergence, at which point training may be completed.

Upon completion of the training, the method may involve testing the combined prediction model based on the test data set. In some embodiments, testing the trained (and validated) combined prediction model may also include evaluating the combined prediction model based on fourth portion of the historical data points that was not included in any of the first group, the second group and the third group. The historical data points in this fourth portion may include, for example, historical activity data associated with one or more accounts that were excluded from the first group, second group and third group. As a result, the historical activity data in this fourth portion was not used to train or validate the combined prediction model. As discussed above, testing the combined prediction model based on this fourth portion of historical activity data may enable the method to evaluate a generalizability of the combined prediction model.

Once testing of the combined prediction model is completed, the method may include selecting the combined prediction model. The method may also include receiving (or retrieving), from one or more third-party systems, a combination of current inflow activity data, current outflow activity data, and current balance information associated with one or more target accounts. Each of the current inflow activity data, the current outflow activity data, and the current balance information may comprise a combination of historical account data, daily cash position data and accounting data. The current inflow activity data, current outflow activity data, and current balance information may comprise a multi-variable data set, and the combined prediction model may be configured to model the multi-variable data set to generate future inflow forecasts and future outflow forecasts for each target account.

In some embodiments, the method may include performing further pre-processing operations on the current inflow activity data, the current outflow activity data, and the current balance information associated with the target account(s). The further pre-processing operations may include, for example, data imputation, feature engineering and data scaling.

The method may further include deploying the combined prediction model and generating, by the combined prediction model, a future inflow forecast and a future outflow forecast for each of the one or more target accounts based on a combination of the current inflow activity data, the current outflow activity data, and the current balance information. As noted above, the future inflow forecast may include inflow forecasts for each of a plurality of time steps in the multi-step time horizon, and the future outflow forecast may include an outflow forecast for each of a plurality of time steps in the multi-step time horizon.

In addition, the method may include determining, based on the future inflow forecast and the future outflow forecast, a future balance forecast for the target account(s) that includes a balance forecast for each of a plurality of time steps in the multi-step time horizon. In some embodiments, the method may include generating, by the combined prediction model, future inflow forecasts, future outflow forecasts and future balance forecasts all at once.

In some embodiments, the method may include retraining the combined prediction model. The retraining may include, for example, evaluating (e.g., over a predetermined period of time) a performance of the combined prediction model based on one or more performance metrics, determining whether at least one of the performance metrics falls below a predetermined threshold based on the evaluating, adjusting the at least one weight parameter based on said determining, and optimizing the objective function based on the adjusted at least one weight parameter.

In some embodiments, the method may further include storing one or more of the future inflow forecast, the future outflow forecast and the future balance forecast in one or more tables for future access and retrieval.

In some embodiments, the method may further include generating a graphical user interface (GUI) that displays one or more of the future inflow forecast, the future outflow forecast and the future balance forecast. In some embodiments, the method may include transmitting the GUI to one or more user devices for rendering and display thereon; while in some embodiments, the method may include rendering the GUI at the system, and then transmitting the rendered GUI to one or more client devices for display thereon.

A non-transitory computer readable medium according to the present disclosure may include one or more sequences of instructions, that, when executed by one or more processors, causes a computing system to perform operations according to exemplary embodiments described herein. In some embodiments, the operations may cause the computing system to generate multi-variable, multi-entity and multi-step time series forecasts, for any length time horizon, all at once.

The operations may include retrieving historical account activity data for a plurality of accounts associated with one or more users. In some embodiments, the plurality of accounts may be associated with multiple users. The historical account activity data retrieved may include historical data points arranged in chronological order for a predetermined number of days (e.g., historical data points for each of 270 consecutive days), including (among others) historical inflow data and historical outflow data.

The operations may further include pre-processing the historical account activity data. In some embodiments, pre-processing may include a combination of data imputation, data filtering, feature engineering and/or data scaling. In some embodiments, data imputation may comprise identifying data among the historical account activity data having missing values, and replacing the missing values with system-generated imputed values. Data filtering may include identifying accounts from among the plurality of accounts that do not have activity data for at least a predetermined number of days (e.g., 270 days, where 180 days comprise a look-back period and days comprise a look-forward period), and removing the activity data associated with the identified accounts from the historical account activity data. Feature engineering may include augmenting the historical account activity data with data indicative of attributes of the historical account activity data, such as of type, value, frequency, purpose, periodicity, day (e.g., of week, of month, etc.), date, etc. of the historical account activity data. Data scaling may include mapping data values associated with each of the plurality of accounts to a same output range according to a cumulative scaler function. In some embodiments, the data scaling may involve mapping the data values to a min-max scale of between, for example, 0 and 1.

Once the historical account activity data is pre-processed, the operations may further include constructing a training data set based on the now pre-processed historical account activity data. In some embodiments, constructing the training data set may involve splitting the historical activity data points into at least three different groups: a first group comprising a first portion of the historical data points, a second group comprising a second portion of the historical data points and a third group comprising a third group of the historical data points. Since the historical account activity data may be arranged in chronological order, the historical data points in each group may also be in chronological order, and each group may have historical data points that do not overlap. Further, the historical data points in the second group may chronologically follow the historical data points in the first group, and the historical data points in the third group may chronologically follow the historical data points in the second group.

Once the historical activity data is split into groups, one of the groups (e.g., the first group) may comprise and be designated as a training data set, another group (e.g., the second group) may comprise/be designated as a validation data set and another group (e.g., the third group) may comprise a test data set (discussed further below).

The operations may further include generating and training a combined prediction model to forecast future inflow activity and future outflow activity for a multi-step time horizon. The multi-step time horizon may comprise any number of days, such as 2 days, 30 days, 60 days, 90 days or more, and the forecasts generated by the combined prediction model may include inflow forecasts for each day in the time horizon, outflow forecasts for each day in the time horizon, and balance forecasts for each day in the time horizon. Thus, if the time horizon is 90 days, the operations may include generating, by the combined prediction model, inflow, outflow and balance forecasts (as well as other forecast variables) for each account for each day in the 90-day time horizon, all at once.

The operations may further include training the combined prediction model based on the training data set. In some embodiments, the operations may include feeding the training data set into the combined prediction model, during the training, according to a stratified sampling process. Training the combined prediction model may include optimizing an objective function of the prediction model by adjusting at least one weight parameter of the objective function based on an accuracy of one or more predictions generated by the combined prediction model during its training. The predictions may include, for example, a combination of projected inflow predictions, projected outflow predictions and differences between the projected inflow predictions and the projected outflow predictions.

The operations may also include assessing the accuracy of the prediction(s) generated during training based on the validation data set, and adjusting the weight parameter(s) in view of such assessments (e.g., based on the validation data set). This process (e.g., assessing predictions, adjusting weight parameter(s)) may be repeated until the combined prediction model reaches an acceptable convergence, at which point training may be completed.

Upon completion of the training, the operations may involve testing the combined prediction model based on the test data set. In some embodiments, testing the trained (and validated) combined prediction model may also include evaluating the combined prediction model based on fourth portion of the historical data points that was not included in any of the first group, the second group and the third group. The historical data points in this fourth portion may include, for example, historical activity data associated with one or more accounts that were excluded from the first group, second group and third group. As a result, the historical activity data in this fourth portion was not used to train or validate the combined prediction model. As discussed above, testing the combined prediction model based on this fourth portion of historical activity data may enable the computing system to evaluate a generalizability of the combined prediction model.

Once testing of the combined prediction model is completed, the operations may further include selecting the combined prediction model. The operations may also include receiving (or retrieving), from one or more third-party systems, a combination of current inflow activity data, current outflow activity data, and current balance information associated with one or more target accounts. Each of the current inflow activity data, the current outflow activity data, and the current balance information may comprise a combination of historical account data, daily cash position data and accounting data. The current inflow activity data, current outflow activity data, and current balance information may comprise a multi-variable data set, and the combined prediction model may be configured to model the multi-variable data set to generate future inflow forecasts and future outflow forecasts for each target account.

In some embodiments, the operations may include performing further pre-processing operations on the current inflow activity data, the current outflow activity data, and the current balance information associated with the target account(s). The further pre-processing operations may include, for example, data imputation, feature engineering and data scaling.

The operations may further include deploying the combined prediction model and generating, by the combined prediction model, a future inflow forecast and a future outflow forecast for each of the one or more target accounts based on a combination of the current inflow activity data, the current outflow activity data, and the current balance information. As noted above, the future inflow forecast may include inflow forecasts for each of a plurality of time steps in the multi-step time horizon, and the future outflow forecast may include an outflow forecast for each of a plurality of time steps in the multi-step time horizon.

In addition, the operations may include determining, based on the future inflow forecast and the future outflow forecast, a future balance forecast for the target account(s) that includes a balance forecast for each of a plurality of time steps in the multi-step time horizon. In some embodiments, the operations may include generating, by the combined prediction model, future inflow forecasts, future outflow forecasts and future balance forecasts all at once.

In some embodiments, the operations may include retraining the combined prediction model. The retraining may include, for example, evaluating (e.g., over a predetermined period of time) a performance of the combined prediction model based on one or more performance metrics, determining whether at least one of the performance metrics falls below a predetermined threshold based on the evaluating, adjusting the at least one weight parameter based on said determining, and optimizing the objective function based on the adjusted at least one weight parameter.

In some embodiments, the operations may further include storing one or more of the future inflow forecast, the future outflow forecast and the future balance forecast in one or more tables for future access and retrieval.

In some embodiments, the operations may further include generating a graphical user interface (GUI) that displays one or more of the future inflow forecast, the future outflow forecast and the future balance forecast. In some embodiments, the operations may include transmitting the GUI to one or more user devices for rendering and display thereon; while in some embodiments, the operations may include rendering the GUI at the system, and then transmitting the rendered GUI to one or more client devices for display thereon.

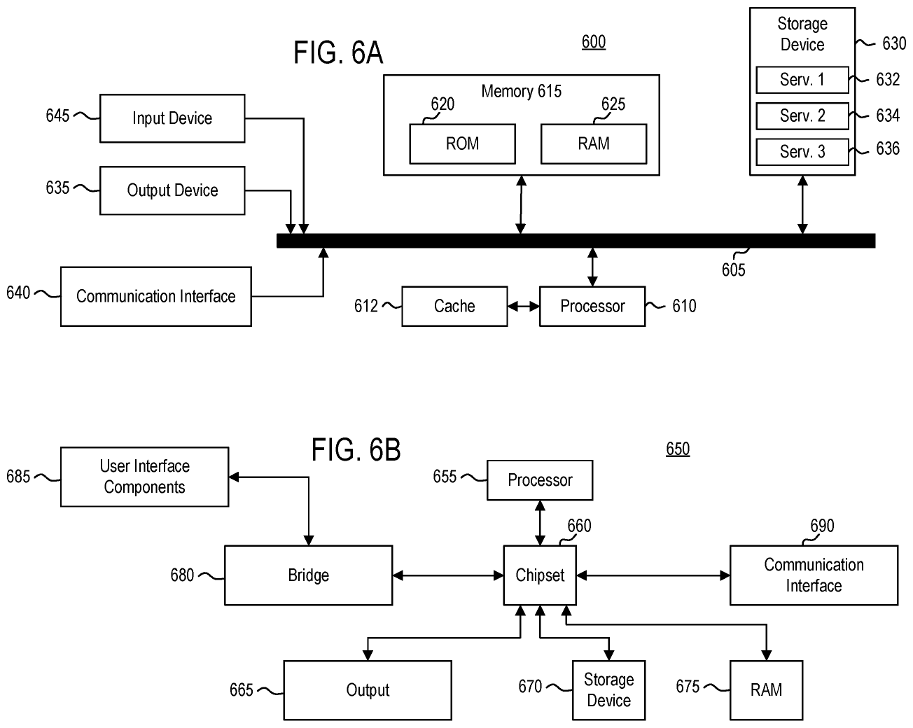

FIG. 6A illustrates an architecture of computing system 600, according to example embodiments. System 600 may be representative of at least a portion of back-end computing system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random access memory (RAM) 625, to processor 610. System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include a processor and a hardware module or software module, such as service 1 632, service 2 634, and service 3 636 stored in storage device 630, configured to control processor 610, as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 (e.g., display) may also be one or more of a number of output mechanisms. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635, and so forth, to carry out the function.

FIG. 6B illustrates a computer system 650 having a chipset architecture that may represent at least a portion of back-end computing system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655. In this example, chipset 660 outputs information to output 665, such as a display, and may read and write information to storage device 670, which may include magnetic media, and solid-state media, for example. Chipset 660 may also read data from and write data to RAM 675. A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or RAM 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

Some portions of the present disclosure describe embodiments in terms of algorithms and/or routines and symbolic representations of operations on information. These algorithmic descriptions and representations are used to convey the substance of this disclosure effectively to others skilled in the art. These operations, while described functionally, computationally, or logically, are to be understood as being implemented by data structures, computer programs or equivalent electrical circuits, microcode, or the like. Furthermore, at times, it may be convenient to refer to these arrangements of operations as routines or algorithms. The described operations and their routines/algorithms may be embodied in specialized software, firmware, specially-configured hardware or any combinations thereof.

The methods described herein (that may be conducted by the learning system of the present disclosure) may be performed by processing logic that may comprise hardware (e.g., circuitry, dedicated logic, programmable logic, microcode, etc.), software (such as instructions run on a processing device), or a combination thereof. In one embodiment, the methods described herein may be performed by one or more specialized processing components described herein.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some embodiments, computers may comprise processors, memories, data storage devices, and/or other components. These components may be connected physically or through network or wireless links. Computers may also comprise software which may direct the operations of the aforementioned components. Computers may be referred to as servers, personal computers (PCs), mobile devices, and other terms for computing/communication devices. For purposes of this disclosure, those terms used herein are interchangeable, and any special purpose computer particularly configured for performing the described functions may be used.

Computers may be linked to one another via one or more networks. A network may be any plurality of completely or partially interconnected computers wherein some or all of the computers are able to communicate with one another. Connections between computers may be wired in some cases (e.g., via wired TCP connection or other wired connection) or may be wireless (e.g., via a WIFI network connection). Any connection through which at least two computers may exchange data can be the basis of a network. Furthermore, separate networks may be able to be interconnected such that one or more computers within one network may communicate with one or more computers in another network. In such a case, the plurality of separate networks may optionally be considered to be a single network.

The term “computer” shall refer to any electronic device or devices, including those having capabilities to be utilized in connection with an electronic information/transaction system, such as any device capable of receiving, transmitting, processing and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with the systems and methods described herein, such as, for example, any public and/or private networks, including, for instance, the Internet, an intranet, or an extranet, any wired or wireless networks or combinations thereof.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

What is claimed is:

1. A system comprising:
one or more processors; and
a memory storing programming instructions that, when executed by the one or more processors, cause the system to:
retrieve historical account activity data for a plurality of accounts, the historical account activity data comprising historical inflow data and historical outflow data;
construct a training data set based on the historical account activity data;
generate a combined prediction model configured to forecast future inflow activity and future outflow activity for a multi-step time horizon;
train the combined prediction model based on the training data set, said training comprising optimizing an objective function of the prediction model by adjusting at least one weight parameter of the objective function based on an accuracy of one or more predictions generated by the combined prediction model during said training, the predictions comprising a combination of projected inflow predictions, projected outflow predictions and differences between the projected inflow predictions and the projected outflow predictions;
receive, from one or more third-party systems, current inflow activity data, current outflow activity data, and current balance information associated with one or more target accounts;
generate, by the combined prediction model, a future inflow forecast and a future outflow forecast for the one or more target accounts based on a combination of the current inflow activity data, the current outflow activity data, and the current balance information,
the future inflow forecast comprising an inflow forecast for each of a plurality of time steps in the multi-step time horizon, and the future outflow forecast comprising an outflow forecast for each of a plurality of time steps in the multi-step time horizon;
determine, based on the future inflow forecast and the future outflow forecast, a future balance forecast for the one or more target accounts that comprises a balance forecast for each of a plurality of time steps in the multi-step time horizon; and
retrain the combined prediction model by:
evaluating a performance of the combined prediction model based on one or more performance metrics,
determining whether at least one among the one or more performance metrics falls below a predetermined threshold based on the evaluating,
adjusting the at least one weight parameter based on said determining, and
optimizing the objective function based on the adjusted at least one weight parameter.

2. The system of claim 1, wherein the plurality of accounts is associated with two or more independent users.

3. The system of claim 1, wherein the programming instructions, when executed by the one or more processors, further cause the system to:
pre-process the historical account activity data, said pre-process comprising one or more of data imputation, data filtering, feature engineering and data scaling.

4. The system of claim 3, wherein data imputation comprises identifying data among the historical account activity data having missing values, and replacing the missing values with system-generated imputed values,
wherein data filtering comprises identifying accounts from among the plurality of accounts that do not have activity data for at least a predetermined number of days, and removing the activity data associated with the identified accounts from the historical account activity data,
wherein feature engineering comprises augmenting the historical account activity data with data indicative of attributes of the historical account activity data, and
wherein data scaling comprises mapping data values associated with each of the plurality of accounts to a same output range according to a cumulative scaler function.

5. The system of claim 4, wherein the predetermined number of days comprises 270 days.

6. The system of claim 4, wherein the data indicative of attributes of the historical account activity data comprises one or more of type, value, frequency, purpose, periodicity, day and date of historical account activity data.

7. The system of claim 1, wherein historical account activity data comprises historical data points arranged in chronological order, and wherein the system constructs the training data set by:
splitting the historical data points into a first group comprising a first portion of the historical data points, a second group comprising a second portion of the historical data points and a third group comprising a third group of the historical data points,
wherein the historical data points in the first group comprise the training data set.

8. The system of claim 7, wherein the training data set is fed into the combined prediction model, during the training, according to a stratified sampling process.

9. The system of claim 7, wherein the second group of historical data points chronologically follows the first group, and wherein the historical data points in the second group comprise a validation data set.

10. The system of claim 9, wherein the third group of historical data points chronologically follows the second group, and wherein the historical data points in the third group comprise a test data set.

11. The system of claim 10, wherein during the training of the combined prediction model, the system determines the accuracy of the one or more predictions based on the validation data set, and adjusts the at least one weight parameter based on the validation data set.

12. The system of claim 11, wherein upon completion of said training, the system tests the combined prediction model based on the test data set.

13. The system of claim 12, wherein said test comprises evaluating the combined prediction model based on fourth portion of the historical data points that was not included in any of the first group, the second group and the third group.

14. The system of claim 1, wherein each of the current inflow activity data, the current outflow activity data, and the current balance information comprises a combination of historic al account data, daily cash position data and accounting data.

15. The system of claim 1, wherein the programming instructions, when executed by the one or more processors, further cause the system to:
perform further pre-processing operations on the current inflow activity data, the current outflow activity data, and the current balance information associated with the one or more target accounts,
said further pre-processing operations comprising one or more of data imputation, feature engineering and data scaling.

16. The system of claim 1, wherein the current inflow activity data, current outflow activity data, and current balance information associated with one or more target accounts comprises a multi-variable data set, and
wherein the combined prediction model is configured to model the multi-variable data set to generate the future inflow forecast and the future outflow forecast for the one or more target accounts.

17. The system of claim 1, wherein the multi-step time horizon comprises two or more days.

18. The system of claim 17, wherein the multi-step time horizon comprises at least 90 days,
wherein the future inflow forecast comprises the inflow forecast for each day in the 90-day time horizon,
wherein the future outflow forecast comprises the outflow forecast for each day in the 90-day time horizon, and
wherein the future balance forecast comprises the balance forecast for each day in the 90-day time horizon.

19. The system of claim 1, wherein the system is further configured to store one or more of the future inflow forecast, the future outflow forecast and the future balance forecast in one or more tables for future access and retrieval.

20. The system of claim 1, wherein the system is further configured to generate a graphical user interface (GUI) that displays one or more of the future inflow forecast, the future outflow forecast and the future balance forecast.

21. The system of claim 20, wherein the system is further configured to transmit the GUI to one or more user devices for rendering and display thereon.

22. The system of claim 20, wherein the system is configured to render the GUI at said system, and transmit the rendered GUI to one or more client devices for display thereon.
